(19) United States
(12) Patent Application Publication
(10) Pub. No.: US 2008/0140493 A1
(43) Pub. Date: Jun. 12, 2008

(54) Systems And Methods For Real-Time Allocation Of Digital Content

(75) Inventor: Douglas J. DeAngelis, Harrisville, NH (US)

Correspondence Address: LATHROP & GAGE LC, 4845 PEARL EAST CIRCLE, SUITE 300, BOULDER, CO, 80301, US

(73) Assignee: LYNX SYSTEM DEVELOPERS, INC., Haverhill, MA (US)

(21) Appl. No.: 11/938,198

(22) Filed: Nov. 9, 2007

Related U.S. Application Data
(60) Provisional application No. 60/858,038, filed on Nov. 9, 2006.

(51) Int. Cl. G06Q 30/00; G06Q 10/00; G06F 17/30

(52) U.S. Cl. 705/8; 705/14; 705/37

(57) ABSTRACT

Systems, methods, and software products allocate digital content in real time. Real-time digital content allocation includes processing sign, sales and buying parameters for a digital sign in a sign database. Real-time digital content allocation also includes processing digital content in a submitted database; permitting access to the submitted database by a digital sign owner, for review of the digital content; saving digital content approved by the digital sign owner to an approved content database; processing bidding parameters for a time slot on the digital sign; auctioning the time slot to providers of the approved digital content; distributing digital content to the digital sign; and airing winning digital content during the time slot.

### RELATED APPLICATIONS

This application claims priority to U.S. Provisional Ser. No. 60/858,038, filed 9 Nov. 2006, incorporated herein by reference.

### BACKGROUND

Narrowcasting refers to the targeted transmission of audio and video content to a controlled and specific output device. In narrowcasting, the content provider caters subject matter to a limited number of people or a specific demographic group. Narrowcasting is now being applied to a new and innovative form of advertising and information dissemination commonly referred to as Dynamic Digital Signage. A Dynamic Digital Sign (DDS) is a device that can show still or moving video. The capability of Dynamic Digital Signage to help marketers effectively communicate with customers, to precisely target the most suitable demographic and obtain instant feedback on a product or service are invaluable to almost every business. This is especially crucial in fast-moving, highly competitive marketplaces where up-to-the-minute information about customers' needs and desires is utilized to both control costs and maximize sales. Dynamic Digital Signage is making noticeable inroads in retail businesses and in entertainment complexes such as movie theatres and sports venues. Transportation centers such as airports are also well suited to the technology.

Digital Signage Networks (DSN) provide content to multiple DDSs from a common source. Advertising is expected to drive the growth of DSNs since retailers are looking for new ways to reach their customers, and advertising agencies have been clambering for new ways to deliver their ads. Current DSN software and infrastructures follow a similar model; that is, they help the user create, manage, and distribute content to DDSs, and then offer verification when the content has aired. This DNS software thus makes sense when the entity creating the content also owns the distribution network. However, it does not provide for distribution of content to DSNs when multiple advertisers and multiple sign owners have a buyer/seller relationship in a distribution network.

Today, the majority of DSN owners stream their own digital content onto digital signs. However, when owners do sell time slots to advertisers, they are often required to enter into long-term contracts such as those used in the television and radio industries. This process can be cumbersome and may result in the DSN owner not having advertisements for certain time slots. For example if one potential advertiser pulls out of a negotiation for a particular, upcoming, time slot, there may not be enough time to work out a contract with another advertiser to fill that slot. The owner may simply be unable to sell a time slot if sufficient time prior to the time slot is not available.

### SUMMARY

In one embodiment, a system for real-time allocation of digital content to a digital sign includes a sign database with information representative of one or more digital signs. A submitted content database stores digital content from a content provider. The content in the submitted content database is reviewable by a sign owner. An auction engine matches the digital content to at least one of the digital signs, and a content distributor distributes the matched content to the digital sign.

In another embodiment, a method for real-time allocation of digital content to digital signs includes: processing sign parameters for a digital sign in a sign database; processing sales parameters for the digital sign in the sign database, processing digital content in a submitted content database; permitting access to the submitted content database for review of the digital content by a digital sign owner, and tagging digital content approved by the digital sign owner with an approval indicator. Bidding parameters for a time slot on the digital sign are processed, and the time slot auctioned to providers of the approved digital content. The content is distributed to the digital sign, and winning content is aired during the time slot.

In another embodiment, a software product has instructions stored on computer-readable media that, when executed by a computer, perform steps for real-time allocation of digital content to digital signs. The software product includes instructions for: obtaining data indicative of sign owner parameters; obtaining data indicative of content provider parameters; identifying content that is approved by the sign owner; carrying out an auction, and distributing approved content to digital signs.

In an embodiment, a system for displaying digital content received over a digital signage network from a remote digital content marketplace includes a digital sign; a receiver, coupled with the digital sign, for receiving digital content that is approved for display on the digital sign; a storage device in communication with the digital sign, for temporarily storing the approved content; a sensor for providing feedback representative of activity local to the digital sign to the receiver; and a transmitter coupled with the receiver, for transmitting the feedback to the digital content marketplace.

In another embodiment, a system for real-time allocation of digital content to a digital sign includes a database with digital sign information of one or more digital signs, and an auction engine for matching digital content to the one or more digital signs.

In a further embodiment, a method allocates digital content to digital signs in real-time. Sign parameters for a digital sign are processed in a sign database. Sales parameters for the digital sign are processed in the sign database. Digital content is processed in a submitted content database. Access to the submitted content database by a digital sign owner is permitted, for review of the digital content and digital content approved by the digital sign owner is tagged with an approval indicator. Bidding parameters for a time slot on the digital sign are processed and the time slot is auctioned to providers of the approved digital content based upon the bidding parameters and the sales parameters. The approved digital content is distributed to the digital sign and approved digital content of the winning provider is aired on the digital sign during the time slot.

In another embodiment, a method for displaying digital content on a digital sign includes accessing a database containing information about one or more digital signs. A digital sign is selected from the database, and digital content is submitted to the database for approval by an owner of the selected digital sign. Approval of the digital content is received from the owner and a bid entered for display of the digital content on the selected digital sign.

In one embodiment, a method for allocating and displaying digital content on dynamic digital signs includes: accepting dynamic digital sign sales parameters for one or more dynamic digital signs of a digital signage network; accepting proposed digital content for display upon at least one of the one or more dynamic digital signs; accepting bidding parameters associated with the proposed digital content; determining an auction close time based upon the dynamic digital sign sales parameters; entering bids to the auction based upon the bidding parameters; auctioning a time slot on the one or more dynamic digital signs based upon the entered bids; determining, at the auction close time, a winning bid; and distributing the digital content associated with the winning bid to the one or more dynamic digital signs for display.

In another embodiment, a method selects and displays digital content within an advertising space. Advertising space sales parameters for one or more advertising spaces are accepted. Proposed content for display within at least one of the one or more advertising spaces is accepted. Bidding parameters associated with the proposed content are accepted. An auction close time is determined based upon the advertising space sales parameters. Bids are entered to the auction based upon the bidding parameters. A time slot for the one or more advertisement spaces is auctioned based upon the entered bids. A winning bid is determined at the auction close time and the content associated with the winning bid is distributed for display within the one or more advertisement spaces.

In another embodiment, a system allocates digital content to an advertisement space in real-time. An advertisement space database includes information representative of one or more advertisement spaces. A content database stores digital content from a content provider and is reviewable by an owner of the one or more advertisement spaces. An auction engine matches the digital content to at least one of the advertisement spaces and a content distributor distributes the matched content to the advertisement space.

### BRIEF DESCRIPTION OF THE FIGURES

FIG. 1A shows one system for real-time allocation of digital content, in accord with an embodiment.

FIG. 1B shows a block diagram illustrating exemplary operation of an auction engine of the system of FIG. 1A.

FIG. 1C shows a block diagram illustrating exemplary operation of a content distributor of the system of FIGS. 1A and 1B, with bundled content.

FIG. 2 is a flowchart illustrating one method for real-time allocation of digital content, in accord with an embodiment.

FIG. 3A is a flowchart illustrating a method for inputting parameters from a digital sign owner

FIG. 3B is a flowchart illustrating a method for inputting parameters from a content provider.

FIG. 3C is a flowchart illustrating a method for reviewing new content.

FIG. 4 shows a dynamic digital sign in use on a highway, in accord with an embodiment.

FIG. 5 is a graph illustrating bidding and reserve pricing in the context of FIG. 4.

FIG. 6 schematically shows an exemplary embodiment of a system for real-time allocation of digital content, with auction software for facilitating auctioning, parameter input and content review as in FIGS. 3A-3C, in accord with an embodiment.

FIG. 7 shows one system for real-time allocation of digital content to one or more personal computers, in accord with an embodiment.

### DETAILED DESCRIPTION

Through the system for real-time allocation of digital content to a dynamic digital sign (DDS) described hereinbelow, an owner of a DDS may sell time slots and assign content to or approve content for that DDS in real-time, based upon current market value. The assigned or approved content may be delivered to the DDS via hard wired communication paths, or the content may be delivered wirelessly. The system thus acts as an intermediate “marketplace” between content providers (i.e., advertisers or buyers of time slots) and sign owners (i.e., owners of a DDS and/or digital signage network (DSN)). Using the following DDS Content Marketplace methodology, regardless of the amount of eligible content, the time between the end of an auction for a time slot and the start of the time slot may be reduced to near zero, given sufficient link speed on the network and local storage on the DDS. Advantages of the system may thus be realized by both sign owners and content providers. That is, the DDS owner sells time slots at a market price based upon demand for the DDS; and the content provider pays a fair market value determined by competing bidders, and therefore does not risk overpaying. Content providers also have the flexibility to decide which time slots are most valuable for their particular messages.

Triggers may be set up by content providers and sign owners such that when the set trigger occurs, the time slot immediately following the trigger is bid upon (i.e., automatically, by the provider) or opened for bidding (i.e., automatically, by the owner). This is for example useful in a sporting event where a trigger is associated with a sponsored athlete breaking a league record. The content provider, in this case the athlete's sponsor, may take advantage of this trigger by having an appropriate advertising clip ready to play when and if the trigger occurs. The sponsor benefits from immediate association of their name and/or product with the record breaking event and the owner may receive a premium for that time slot, for example. Other triggers include, but are not limited to, temperature and other weather conditions, market conditions, traffic accidents and delays in public transportation.

The DDS Content Marketplace methodology described hereinbelow may provide a virtual “wall” between the sign owner and the content provider such that the lowest price the sign owner is willing to accept for a given time slot, and the highest price the content provider is willing to pay for a given time slot, remain private. The sign owner may create different pricing rules for the sign at any granularity (i.e., down to one minute or less) and set a “reserve” price, below which the sign plays a default clip (i.e., an advertisement for the DDS itself) or nothing at all.

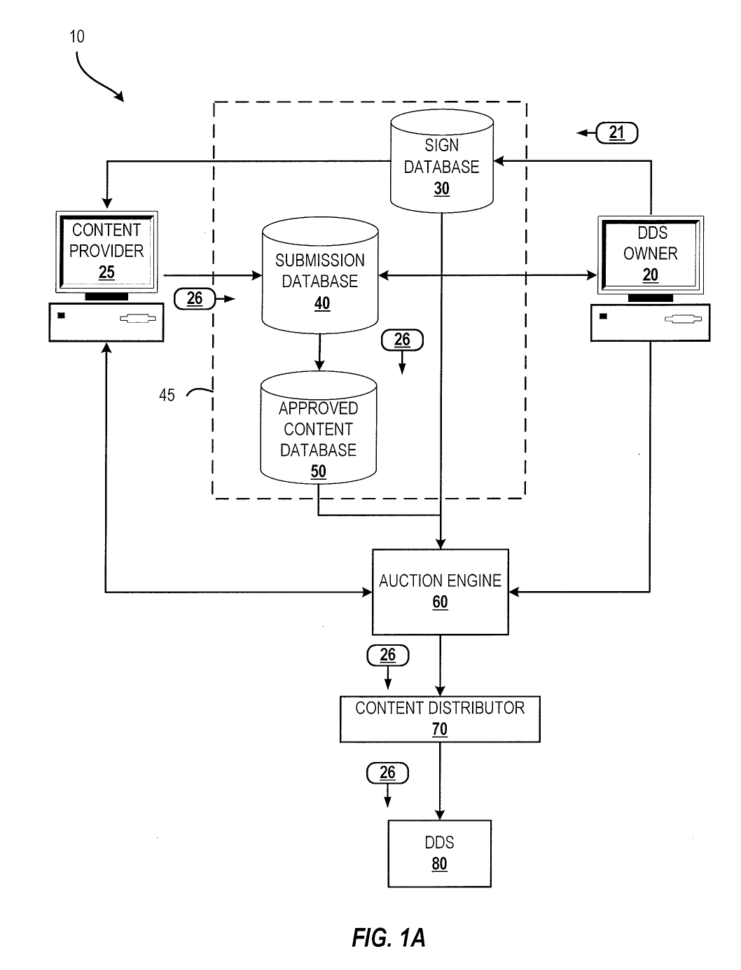

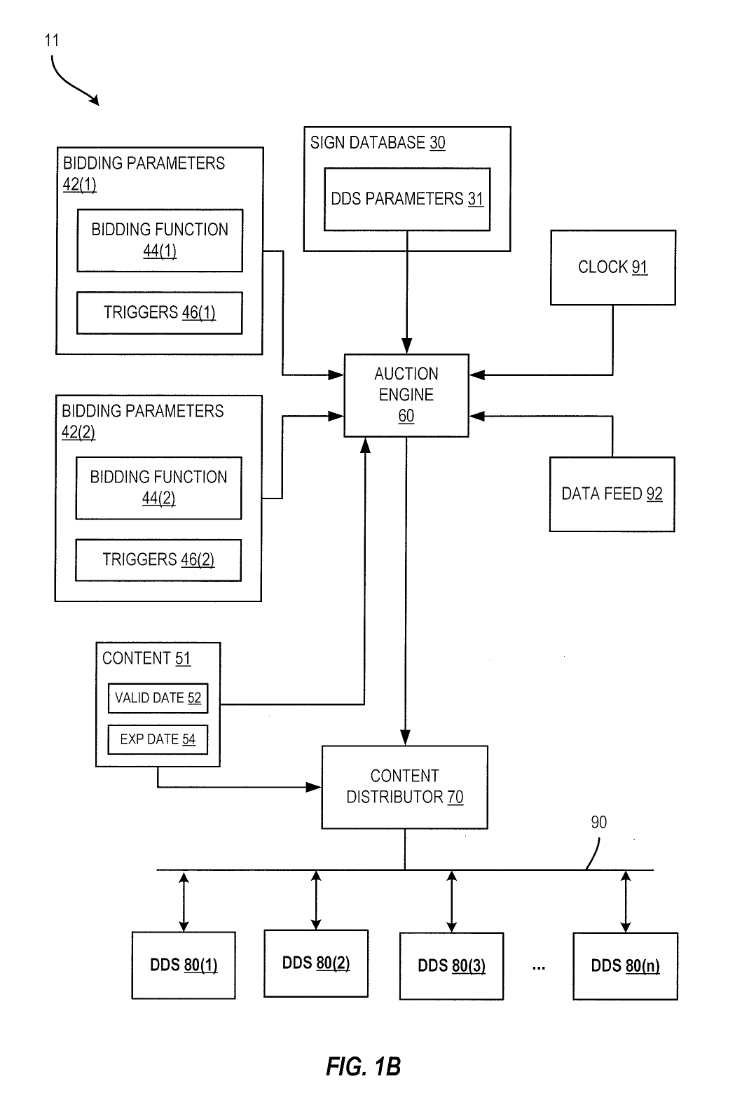

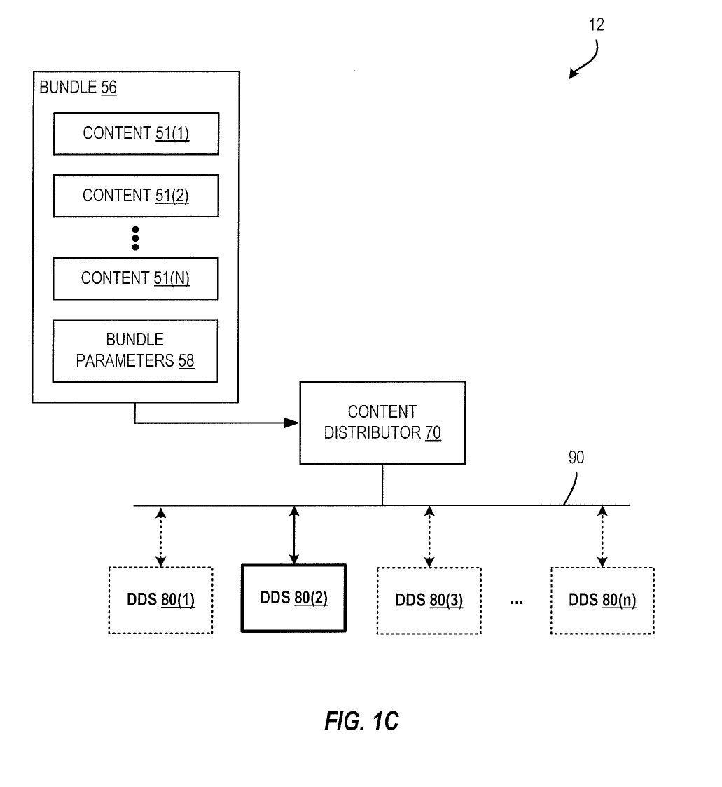

FIG. 1A schematically shows one system 10 for real-time allocation of digital content. A sign database 30 is populated with information (e.g., DDS information 21) of one or more DDSs (e.g., a DDS 80) owned by one or more DDS owners (e.g., DDS owner 20 that is shown as a computer terminal communicatively connected with system 10). Owner 20 for example pays a fee to register or list DDS 80 with system 10. Sign database 30 contains information of DDS 80 including pertinent details associated with selling display space and time on DDS 80. A content provider 25 (also shown as a computer terminal communicatively connected with system 10) searches sign database 30 for a sign that meets desired advertising criteria. In one example, content provider 25 accesses sign database 30 via the Internet using the illustrated computer terminal. Upon selecting a suitable DDS (e.g., DDS 80 in this example) from sign database 30, content provider 25 submits content 26, such as digital media that is properly formatted and tagged for DDS 80, to a submission database 40. Sign owner 20 accesses submission database 40 to evaluate content 26 submitted for DDS 80. If approved, content 26 is stored in an approved content database 50. Sign database 30, submission database 40 and approved content database 50 may be part of the same database 45, as shown. In one example, submission database 40 and approved content database 50 are subsets of a single content database (not shown). In one embodiment, submission database 40 and approved content database 50 are combined and include one or more fields associated with each item of submitted content, to indicate approval or disapproval for selected DDSs. Approved content database 50 thus includes content (e.g., content 26) that is suitable (per criteria of DDS owner 20) and ready to be played on DDS 80. Content provider 25 is therefore eligible to participate in an auction for one or more time slots of DDS 80 in which to display the content. Potential content for DDS 80 is “approved” by owner 20 in advance of any time slot auction associated with DDS 80, and may be loaded into memory of DDS 80 such that it is ready to be displayed on DDS 80. Content (e.g., content 26) may be approved by multiple DDS owners for playing on multiple DDSs.

An auction engine 60 matches content providers 25 to sign owners 20 based upon approved content for each DDSs (e.g., DDS 80), and then determines which, if any, approved content is selected for display upon each DDS using a bidding methodology. Auction engine 60 employs one or more bidding methodologies defined by each DDS owner (e.g., DDS owner 20). Bidding methodologies include, but are not limited to, fixed or variable price, pricing granularity, and using a traditional or reverse auction. In an embodiment, auction engine 60 creates a virtual “wall” between content provider 25 and sign owner 20 such that the bidding methodology, the reserve price for time slots, the maximum bid and the latest bid are not available to the content providers and/or DDS owners (e.g., the DDS owner is not aware of the content providers maximum bid and the content provider is not aware of the reserve price for time slots).

Upon closing of an auction for a particular timeslot, auction engine 60 passes the identification of the winning content (content 26 in this example) and associated provider 25 to a content distributor 70. Content distributor 70 then distributes or allocates the winning content (or identification thereof where approved content has already been distributed and stored within memory of the DDS) to one or more DDSs (e.g., DDS 80) upon which it is to be displayed. Allocation or identification of content for example occurs in real-time, upon closing of the auction. Content distribution may be similar to distribution in existing DSNs, with enhancements to permit real time operation. Where a DDS has limited local storage, content distributor 70 may evaluate the speed of potential content distribution paths to ensure that the auction ends soon enough to allow any content to be delivered to the sign prior to scheduled display time. DDS 80 has local storage to hold approved content (e.g., sufficient local storage to hold all approved content for DDS 80 for an appropriate period, such as ten minutes). This local storage is updated by content distributor 70 to ensure that content for display upon the DDS is local prior to its designated time slot. Thus, when an auction ends, content distributor 70 transfers the identity of the winning content to DDS 80 and any content no longer required may be flushed from the DDS local storage.

In an embodiment, sign database 30, submission database 40, approved content database 50, auction engine 60 and content distributor 70 are located on a server that is accessible by both owner 20 and content provider 25. In another embodiment content distributor 70 is a wireless device that is remote from a server that includes databases 30, 40 and 50 and auction engine 60. Sign database 30, submission database 40, approved content database 50 and auction engine 60 may be located on a single server, multiple server(s) at a single location or multiple servers at a number of locations.

FIG. 1B shows a block diagram 11 illustrating exemplary operation of auction engine 60 of FIG. 1A. Sign database 30 has a set of DDS parameters 31 that define operational parameters of DDS 80. Auction engine 60 receives data relating to content 51 (e.g., within approved content database 50). For example, auction engine 60 utilizes tags associated with content 51 when determining eligibility of content for entry into the time slot auction. Such tags include information representative of bidding parameters 42. Bidding parameters 42 are for example input by content provider 25 when inputting new content into submission database 40. Content 51 represents content approved by DDS owner 20.

Content 51 may also have an associated valid date 52 that specifies a date range when content 51 may be shown. For example, valid date 52 is specified by the content provider (e.g., content provider 25) to define a period during which content 51 may be played. Content 51 may also have an associated expiry date 54 that specifies a date and time after which content 51 cannot be played on a particular DDS 80 without re-approval. For example, expiry date 54 is specified by a DDS owner 20 to require re-approval of content 51 after the specified expiry date 54. Valid date 52 and expiry date 54 are shown within content 51 but are preferably stored within approved content database 50.

Content distributor 70 is illustratively shown connecting to a DSN 90 with multiple DDSs 80(1)-80(n). Content distributor 70 and DDSs 80 may interconnect wirelessly. Optionally, DDSs 80 may be seamlessly added and removed to/from DSN 90.

Auction engine 60 determines auction close time for each time slot of each DDS 80 based upon DDS parameters 31 stored within sign database 30, and input from clock 91. DDS parameters 31 are, for example, entered by owner 20 to define sign location, times of sign operation, time slot or spot periods (e.g., start time and duration), a minimum price for each time slot or spot, number of pixels, resolution, refresh rate, the DDS connection bandwidth, anticipated visibility as a function of time of day, anticipated impression (e.g., number of viewers who will see the sign) as a function of time of day, anticipated impression as a function of an event proximate the DDS, length of impression, anticipated viewer demographics, acceptable content ratings, pricing granularity, type of auction and the like.

Clock 91 is a real time clock that provides the current time to auction engine 60. Data feed 92 is for example live input from a sporting event, live money market data, or any other live data feed, such as current temperature near the selected DDS. In one embodiment, each DDS returns local data to auction engine 60 via content distributor 70 and/or data feed 92.

Based upon the current time, received from clock 91, the defined time slot periods and the bandwidth, auction engine 60 determines a closing time for each time slot auction. The closing time is selected to allow sufficient time, prior to commencement of the auctioned slot, for determining a winning bid and uploading the wining content to the associated DDS 80 (if not already uploaded with other approved content, as described above). Where approved content is stored locally to each DDS, the connection bandwidth is less significant, and auction close times may be within seconds of each time slot start time. Thus, auction engine 60 may operate in real time, where auctions for each time slot of each DDS close moments prior to the start of the time slot.

Auction engine 60 may evaluate bidding parameters 42 associated with the bids of one or more content providers 25, to determine an auction winner. For example, each content provider 25 may specify bidding parameters 42 that govern play of his content on a DDS (or entry of his approved content into an auction). Bidding parameters 42 include, but are not limited to, bidding formulae 44 (also referred to herein as bidding functions 44) and triggers 46. Bidding parameters 42 and triggers 46 may also affect bidding according to factors such as sign pixels, sign resolution, sign refresh rate, spot or slot duration or time, times of sign operation, location of sign, anticipated impressions as a function of time of day, anticipated length of impression and anticipated viewer demographics.

Triggers 46 may provide input to bidding functions 44 that define bidding strategies. Where multiple time slots are selected for bidding upon, a content provider 25 for example specifies budget caps (e.g., a total amount of money available over a specified period) and repeat time intervals (i.e., minimum amount of time that must pass between consecutive airings of the same content) in bidding formulae 44. If the set budget cap is met, or if the repeat time interval is not met, content from a provider 25 does not play on a selected DDS, even if that content provider 25 is the “first winner” of a time slot auction. In another example, where information related to the bidding formulae is not available prior to commencement of an auction, provider 25's approved content may not enter the auction. The approved content may, for example, be held from entering one auction while it is tied up in another auction. Once the results of the other auction are known, the effects of the other auction on budget caps, time intervals or other bidding formulae may be determined and the approved content entered into subsequent auctions, if appropriate.

Triggers 46 may be entered such that bidding for a time slot auction only occurs when trigger 46 conditions are met. In one example, trigger 46(1) specifies that the DOW industrial average must be greater than a specified amount. Thus, associated content 51 only enters bidding for time slots when the DOW industrial average is greater than the specified amount.

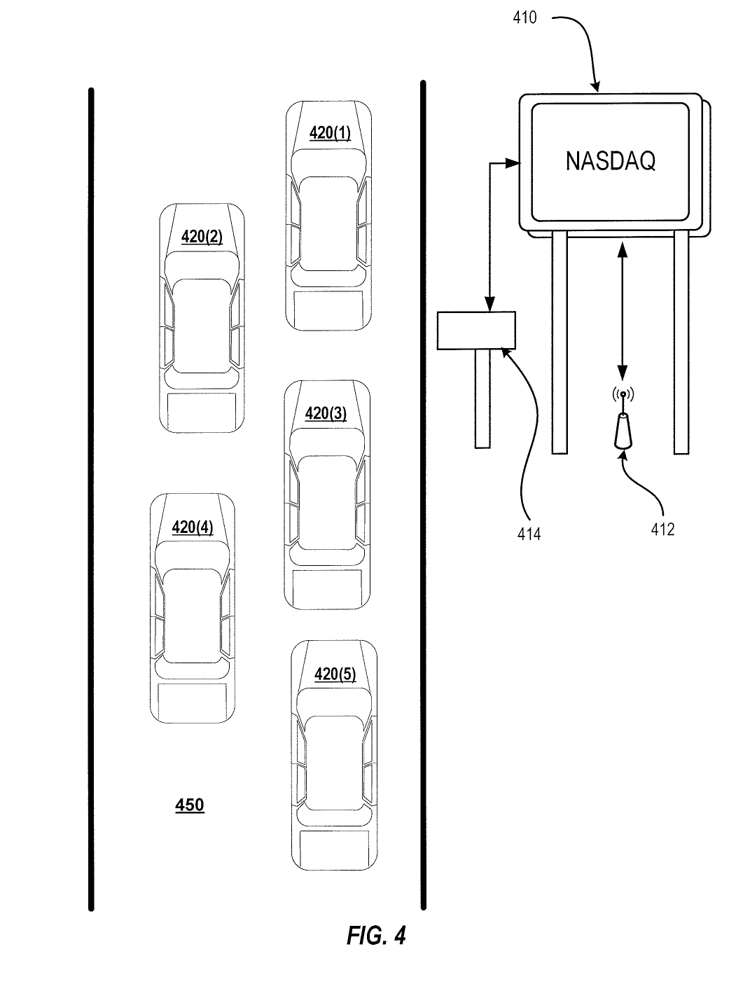

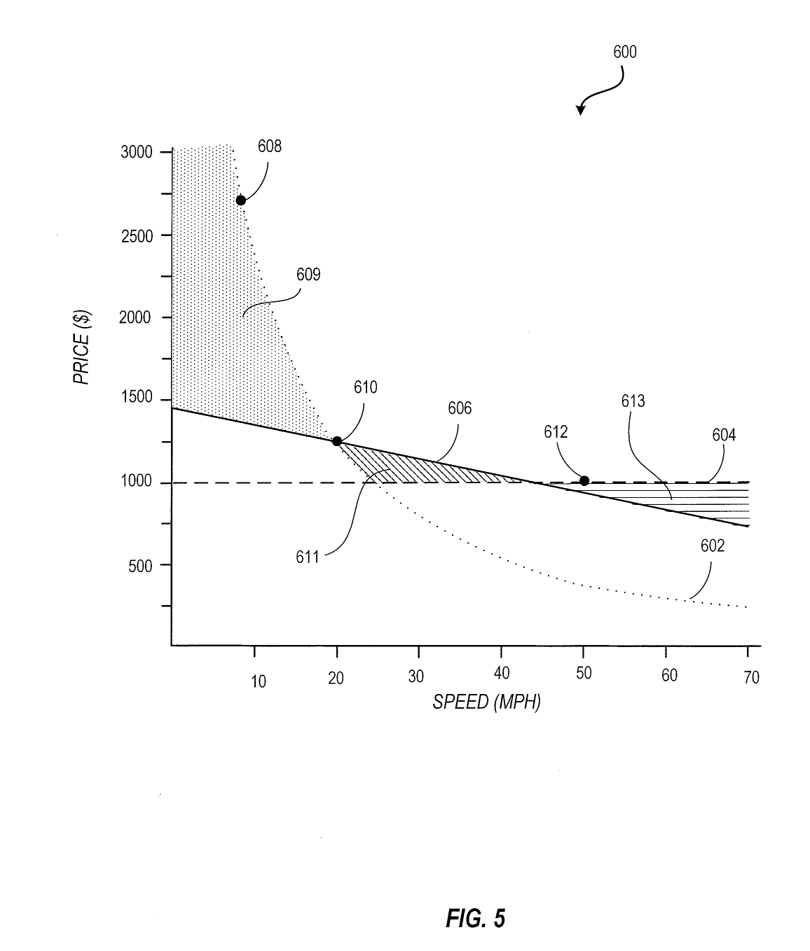

Similarly, bidding parameters 42(2) may for example specify that the DOW industrial average must be lower than the same specified amount. Thus, approved content of content provider 25 may automatically enter bidding based upon an external data feed 92 that delivers current DOW industrial average data to auction engine 60. In another example, bidding functions 44 may be defined to determine a maximum bid value based upon specified data feed values. Further examples of bidding functions 44 and triggers 46 are described in association with FIGS. 4 and 5. In one example, DDS owner 20 advertises appropriate data feed items that may be selected for use with bidding functions 44 and triggers 46, in association with a particular DDS 80.

In one embodiment, DDS parameters 31 also define a minimum and/or maximum content duration for the associated DDS 80. DDS owner 20 for example specifies time slots to be auctioned for each minute of an operational period and requires that display content be one minute in length. In another example, DDS owner 20 specifies a time slot duration of one minute and requires that content, or “spot,” duration is 5 minutes. Thus, for content to display, five consecutive time slots must be won.

Where DDS parameters 31 specify a reserve value for one or more time slots, no content is distributed by content distributor 70 if this value is not reached at the close of auction. Optionally, DDS owner 20 specifies default content, such as a public service announcement or the time of day, for display when the reserve value for a time slot is not met.

FIG. 1C shows a block diagram 12 illustrating exemplary operation of content distributor 70 of FIGS. 1A and 1B with bundled content 51(1)-51(N). A bundle 56 is formed of two or more associated content 51 (shown as content 51(1)-51(N), where N is an integer number greater than one) and bundle parameters 58 that specify one or more scheduling relationships for content 51(1)-51(N). For example, content provider 25 submits bundle 56 containing related media sequences approved as content 51(1)-51(N), bundle parameters 58 and one set of associated bidding parameters 42. Upon winning a time slot auction for DDS 80(2), content distributor 70 utilizes bundle parameters 58 to determine which of content 51(1)-51(N) to play within the timeslot. For example, bundle parameters 58 specify that each of content 51(1)-51(N) be selected in turn for display within won timeslots. In another example, bundle parameters 58 specify a ratio or percentage for display of each of content 51(1)-51(N).

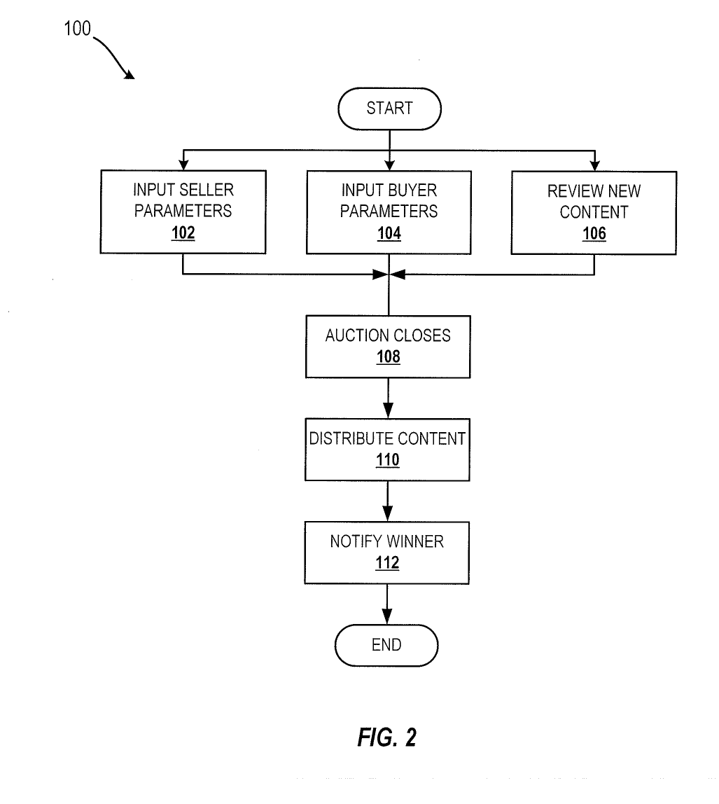

FIG. 2 is a flowchart illustrating one method 100 for real-time allocation of digital content. A DSN owner owns one or more digital signs on the network, and/or serves as manager of the network, for example charging a fee for managing the network and allowing sign owners 20 to associate their signs with the network. In one example, system 10 (FIG. 1A) follows the steps of method 100 to allow entry of parameters from both the sign owners (e.g., sign owner 20) and the content provider (e.g., content provider 25) to be entered prior to an auction being held to determine which content is displayed upon each DDS.

Step 102 of method 100 inputs seller parameters for one or more DDSs. In one example of step 102, owner 20 enters information of DDS 80 into system 10. In step 104, parameters are entered by a buyer/content provider. In one example of step 104, content provider 25 selects DDS 80 and enters new content for DDS 80 into system 10; the new content is stored in submission database 40. In step 106, the new content is reviewed by the appropriate DDS owner. In one example of step 106, owner 20 reviews the new content entered in step 104 to determine if it is acceptable for DDS 80; and, if so, the new content may be moved to approved content database 50. Steps 102, 104 and 106 may occur at any time prior to step 108. For example, owner 20 inputs parameters of DDS 80 for a particular time slot at any time prior to the close of the auction for that time slot, in step 108. Content provider 25 may submit new content for a particular time slot of DDS 80 at any time prior to the close of the auction for that time slot (step 108). Owner 20 may review the new content input in step 104, at any time prior to the close of the auction for the associated time slot (Step 108). Further, where there are multiple DDS owners, multiple content providers, multiple DDSs and multiple time slots for the DDS, steps 102, 104 and 106 may repeat many times prior to step 108.

In step 108, the auction closes and the bidding is evaluated to determine if and which content is to be displayed upon the associated DDS. In particular, step 108 occurs a certain period prior to each time slot of each DDS within system 10. In one example of step 108, system 10 determines that content provided by content provider 25 has won the auction for the next time slot of DDS 80. In step 110, method 100 distributes the winning content to the associated DDS. In one example of step 110, system 10 distributes the winning approved content from approved content database 50 to the associated DDS 80. In step 112, method 100 notifies the content provider who won the auction that their submitted content will be displayed upon the associated DDS in the associated time slot. In one example of step 112, system 10 sends a notification message to content provider 25 that submitted content for DDS 80 will be displayed. This notification message may include specific results of the auction closed in step 108, including the closing price.

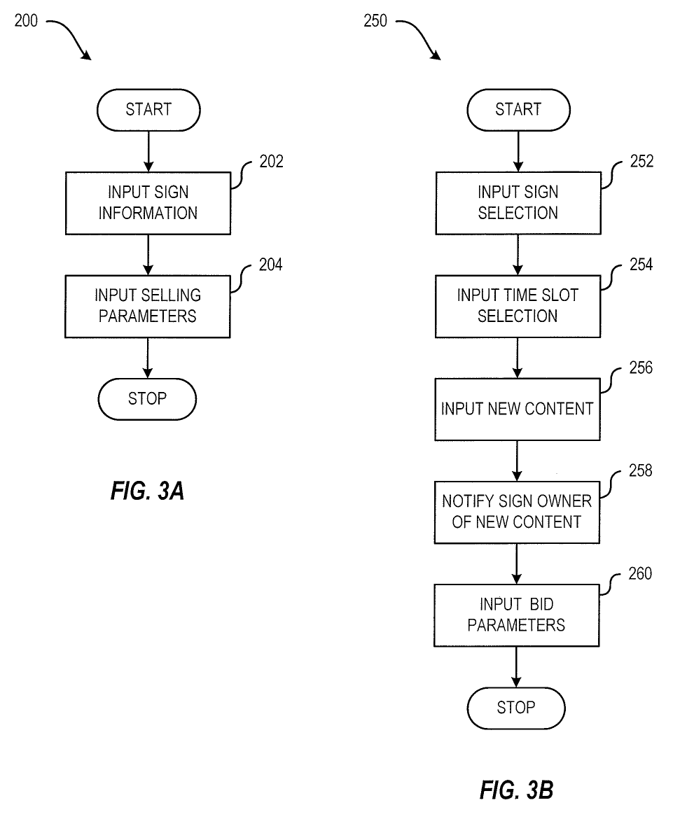

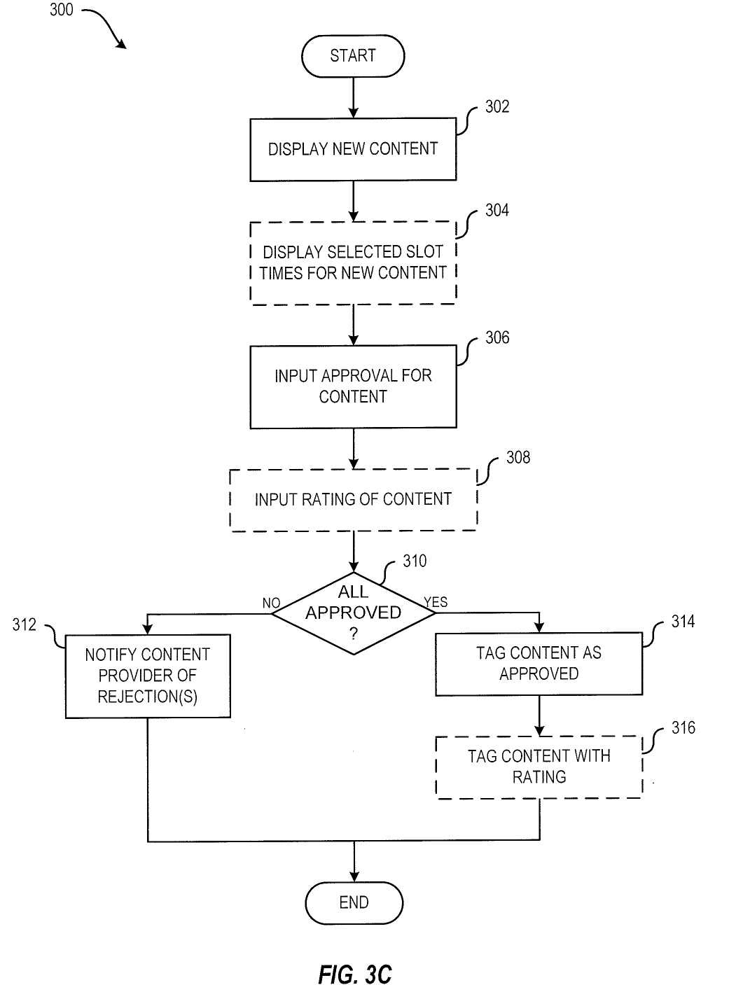

FIG. 3A is a flowchart illustrating one exemplary method 200 for inputting parameters from a DDS owner. Method 200 may represent step 102 of method 100, FIG. 2. In step 202, DDS information is input. In one example of step 202, DDS owner 20, FIG. 1A, inputs parameters of DDS 80 into system 10. These parameters for example include specifications of formats displayed by DDS 80, time slot availability and any further parameters input by the sign owner. In step 204, method 200 inputs selling parameters of the available DDS time slots. In one example of step 204, owner 20 inputs pricing formula for determining a minimum price for each time slot of DDS 80.

FIG. 3B is a flowchart illustrating one exemplary method 250 for inputting parameters from a content provider. Method 250 may represent step 104 of method 100, FIG. 2. In step 252, method 250 inputs selection of DDS. In one example of step 252, content provider 25, FIG. 1, selects DDS 80 for display of their new content. In step 254, method 250 inputs selection of one or more time slots for each of the DDS selected in step 252. In one example of step 254, content provider 25 selects one or more time slots of DDS 80 for display of their new content. In step 256, method 250 inputs new content for the selected DDS of step 252 and time slots of step 254. In one example of step 256, content provider 25 inputs new content into submission database 40 tagged for display on one or more time slots of DDS 80. In step 258, method 250 notifies the owner(s) of the signs selected in step 252 of new content awaiting review. In one example of step 258, system 10 sends a message informing owner 20 of new content input by content provider 25 that is associated with DDS 80. In step 260, method 250 inputs bid parameters associated with the selected sign, selected time slots and input content of steps 252, 254 and 256, respectively. In one example of step 260, content provider 25 inputs one or more formulae that define the bidding associated with the new content provided for display upon DDS 80 and selected time slots thereof.

FIG. 3C is a flowchart illustrating one exemplary method 300 for reviewing new content. Method 300 may represent step 106 of method 100, FIG. 2. In step 302, the new content is displayed to the owner of the associated DDS. In one example of step 302, system 10 displays the new content input in step 256 of method 250, FIG. 3B, to owner 20. Step 304 is optional, occurring if the new content is to be approved for display at various slot times. In step 304, method 300 displays selected slot times associated with the new content. In one example of step 304, system 10 displays selected slot times associated with the new content to owner 20. In step 306, method 300 inputs approval, or disapproval, from the owner of the DDS. In one example of step 306, owner 20 inputs approval of the new content provided by content provider 25 for DDS 80. Step 308 is optional, occurring if the new content is to be rated, e.g., for display at various slot times. In step 308, a rating for the new content is input. The rating for example indicates the content's suitability for display at various periods through the day. Step 310 is a decision. If, in step 310, the new content has been approved for all selected time slots, method 300 continues with step 314; otherwise method 300 continues with step 312. In step 312, method 300 notifies the content provider of the new content that it has not been approved. The content provider may then modify the content and resubmit it for approval in all time slots, or withdraw the content from non-approved time slots. The content provider for example modifies the time slots selected in step 254, FIG. 3B, to include only those time slots for which the content has been approved.

In step 314, method 300 tags the new content as approved. In one example of step 314, system 10 moves the new content from the submissions database 40 to the approved content database 50. Step 316 is optional, occurring if the new content is rated. In step 316, the new content is tagged with the rating determined in step 308. In one example, the new content is tagged with a “PG” rating. If the sign owner has indicated acceptable ratings for additional available time slots on the DDS (e.g., in step 202 of method 200 (FIG. 3A)), the content provider may bid to display the tagged content at an additional time slot that accepts “PG” content, without requiring further approval from the sign owner.

FIG. 4 illustrates one application of system 10, FIG. 1, for real-time allocation of digital content described herein. A DDS 410 is shown adjacent to a highway 450 and attached to a remote DSN through a wireless transceiver 412. Wireless transceiver 412 may continually or periodically receive and locally store content for future display. A sensor 414, in communication with system 10, detects the current speed of automobiles 420(1)-420(5) on highway 450. Sensor 414 relays information representative of automobile speed to system 10, for example via wireless transceiver 412, for use by a content provider, sign owner or both. The sign owner then sets reserve prices for time on digital sign 410 based on the average or current speed in a specific time slot. For example, when automobiles 420(1)-420(5) are in a traffic jam due to rush hour or an unforeseen event, the sign owner may wish to raise reserve prices for advertising to an essentially captive audience. Sign owners may provide traffic speed statistics or real-time data to content providers, who may be willing to pay a premium to advertise during traffic jams. For example, a sign owner posts or automatically directs traffic speed information to system 10, for access by content providers. As bids are entered and as bids fluctuate, e.g., due to traffic conditions mentioned above, system 10 continually updates auction status to indicate the current “winner.”

FIG. 5 is a graph 600 illustrating one example of dynamic bidding and bid tracking. For ease of illustration, FIG. 5 is described in the context of FIG. 4, and the following description may be best understood by viewing FIGS. 4 and 5 together. For ease of illustration, FIG. 5 is described in terms of one-minute advertisements. However, it will be understood that content and time slots may be less or more than one minute. Likewise, the content may be a still image that a content provider wishes to display for the duration of a slot, e.g., for twenty seconds.

As shown in FIG. 5, a first content provider and a second content provider have one-minute adds, both approved for play on a digital sign, such as DDS 410, FIG. 4. The sign owner has selected a traditional auction with a dynamic reserve price (indicated by line 602) of

$$\frac{\$20 , 000}{mph} ,$$

for one minute of air time at 5:00 PM. The denominator, mph, is for example defined within limits of the law and predicted traffic flow, e.g., as ten to 75 mph. In this example, the 5:00 time slot has a reserve price of $500 if automobiles 420(1)-420(5) move at 50 mph, and a reserve price of $1000 if they move at 25 mph.

The first content provider has entered a flat bid of $1,000 (indicated by line 604) for the 5:00 time slot, regardless of car speed. The second content provider has defined a bidding function of $700+$10(75−mph), indicating a base bid of $700, plus an additional $10 for every mph under 75. The second content provider's bidding function is represented by line 606. For ease of illustration, the sign owner, first content provider and second content provider are referred to by their bidding line numbers, as owner 602, first provider 604 and second provider 606.

At point 608, traffic is moving at about 10 mph. At this speed, the reserve price for the 5:00 slot is:

$$\frac{\$25 , 000}{10} = \$2500 \qquad Eq . 1$$

Provider 604's flat bid is well beneath the reserve. Provider 606's dynamic bid likewise falls below the reserve:

$700+$10(75−10)=$1350 Eq. 2.

If the auction ends at point 608, e.g., due to time constraints, neither first or second content provider 604 or 606 wins, and sign 410 may remain blank, play an advertisement for time on sign 410 or play a public service announcement. Zone 609 illustrates a range of price and speed conditions under which sign 410 would remain blank or play such an add or announcement.

At point 610, traffic is moving at about 20 mph. At this speed, owner 602's dynamic reserve price for the 5:00 time slot is:

$$\frac{\$25 , 000}{20} = \$1250 \qquad Eq . 3$$

Provider 604's flat bid does not equal the reserve price set by owner 602; however, provider 606's dynamic bid has met the reserve price:

$700+$10(75−20)=$1250 Eq. 4

Thus, at point 610, provider 606 is winning the auction. Zone 611 illustrates a range of speed and price conditions where provider 606 wins the auction.

At point 612, traffic is moving at about 50 mph, hence, provider 604's flat bid of $1000 beats both the dynamic reserve and the dynamic bid set by provider 606. For example, at point 612, owner 602's dynamic reserve is:

$$\frac{\$25 , 000}{50} = \$500 \qquad Eq . 5$$

and provider 606's bid is:

$700+$10(75−50)=$925 Eq. 6.

Were the auction to end at point 612, provider 604 would win, and his or her approved content would play on sign 410. Zone 613 shows exemplary speed/price conditions where provider 604 wins the auction. This assumes that provider 604 has not entered additional bidding parameters that would cause withdrawal of his or her bid. In one example, provider 604 bids to play identical approved content on both the 5:00 slot and an earlier 4:45 PM slot, and enters a bidding parameter requiring 20 minutes to elapse between consecutive displays of the same approved content. If provider 604 wins the 4:45 slot, his or her bid is automatically withdrawn from the 5:00 auction. In another example, provider 604 wishes to air a two-minute advertisement, and must therefore win both the 5:00 time slot and a 5:01 timeslot on sigh 410. Provider 604 sets a bidding parameter that withdraws or blocks his or her bid if the 5:01 time slot is not won, for example by 4:58 PM. If the 5:01 time slot is not won, provider 606 wins the auction.

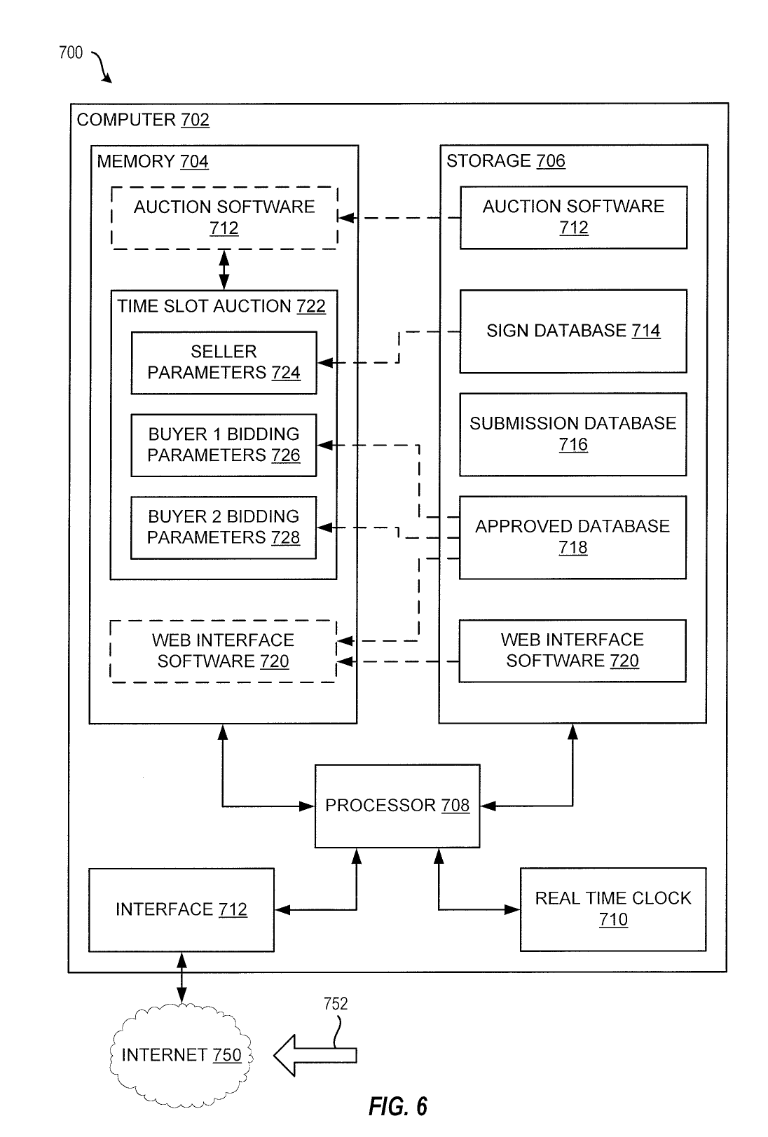

FIG. 6 schematically shows an exemplary embodiment of a system 700 for real-time allocation of digital content, with auction software for facilitating auctioning, parameter input and content review as in FIGS. 3A-3C. For ease of illustration, system 700 is described with respect to FIGS. 4 and 5, above.

System 700 includes a computer 702 having a memory 704, internal storage 706, a processor 708, an interface 712 and a real time clock 710. Memory 704 is, for example, random access memory (RAM). Internal storage 706 is, for example, a magnetic disk drive or other non-volatile storage medium. Optionally, storage 706 is augmented or replaced with external storage in communication with computer 702. Storage 706 is shown with auction software 712, a sign database 714, a submission database 716, an approved database 718 and web interface software 720. Auction software 712 may for example provide functionality of auction engine 60, FIG. 1. Web interface software 720 may represent a web server that provides access to databases 714, 716 and 718 via interface 712 and internet 750. Databases 714-718 for example include information submitted to sign database 30, submission database 40 and approved content database 50 (FIG. 1A), respectively.

Processor 708 loads auction software 712 and web interface software 720 into memory 704 for execution. Auction software 712 and web interface software 720 are shown in dashed outline within memory 704 for purpose of illustration. In the example of FIG. 6, memory 704 also includes information pertaining to a time slot auction 722 of one or more time slots of road-side DDS 410, FIG. 4. Time slot auction 722 is shown with seller parameters 724, buyer 1 bidding parameters 726 and buyer 2 bidding parameters 728. Seller parameters 724 are, for example, retrieved from database 714 by auction software 712. Buyer 1 bidding parameters 726 and buyer 2 bidding parameters 728 are, for example, retrieved from approved database 718 by auction software 712 based upon the DDS and time slot of time slot auction 722. Buyer 1 bidding parameters 726 and buyer 2 bidding parameters 728 may each include bidding functions (e.g., bidding function 44, FIG. 1B) and triggers (e.g., triggers 46) that define auction bids input by two content providers (e.g., content providers 25, FIG. 1A) for a time slot, such as a one minute time slot at 5 PM of DDS 410. In this example, auction software 712, using real time clock 710, loads time slot auction 722 into memory 704 at close of the auction for this time slot.

In one example, seller parameters 724 include the dynamic reserve price of

$$\frac{\$20 , 000}{mph} ,$$

for one minute of air time at 5:00 PM, set by sign owner 602 (FIG. 5). Buyer 1 bidding parameters 726 include the $1,000 flat bid set by provider 604. Buyer 2 bidding parameters 728 include the bidding function ($700+$10(75−mph)) set by provider 606. Seller and buyer parameters 724-728 are entered into databases 714, 716 and 718 of system 700 by owner 602 and content providers 604, 606, e.g., via Internet 750, interface 712 and web interface software 720, at any time prior to the close of the auction for this time slot.

Sensor 414, FIG. 4, periodically sends information (illustratively shown as arrow 752) representative of automobile speed 420(1)-420(5) on highway 450 to system 700, for example via wireless transceiver 412 and Internet 750. Auction software 712 utilizes this information to evaluate the dynamic reserve price of seller parameters 724 and the bidding function of buyer 2 bidding parameters 728 to determine the winner of time slot auction 722. As shown and described with respect to FIG. 5, if sensor 414 determines automobile speed as 20 mph, buyer 2 bidding parameters 728 dictate that buyer 2 wins the auction; if sensor 414 determines automobile speed to be 50 mph, buyer 1 bidding parameters 726 result in a win; and if sensor 414 determines an automobile speed of 10 mph, neither buyer 1 bidding parameters 726 nor buyer 2 bidding parameters 728 lead to a win, since the determined reserve price specified by seller parameters 724 is reached. Information from sensor 414 may also determine whether a buyer's content enters active bidding. For example, buyer 1 may set a bidding trigger at 50 mph or less, such that buyer 1's content does not enter (or is removed from) bidding if traffic is moving faster than 50 mph immediately prior to a desired time slot. Information from sensor 414 may also be received by sensor 700 at any time prior to auction or at the close of auction.

At each auction close for each time slot of each DDS, as determined by auction software 712 (e.g., using real time clock 710 and databases 714, 716 and 718), seller parameters and buyer parameters are evaluated to determine a winner of the auction. Auction software 712 then instructs content distributor 70 (FIG. 1A) to distribute and/or initiate display of the associated content on the associated DDS. For example, where content is stored locally at the DDS, auction software 712 initiates display of the content by sending a message to the DDS, for example via interface 712 and internet 750. The message may include instructions to delete losing content from the DDS and to air the winning content.

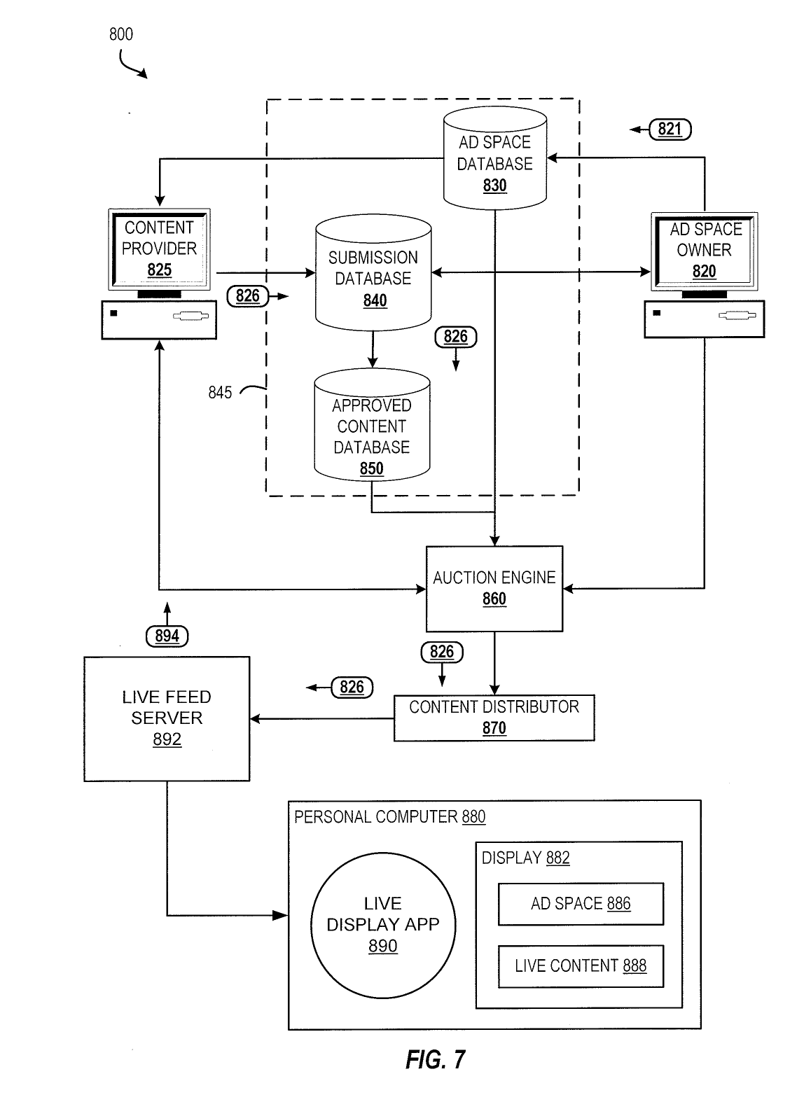

The term digital signage may also be used to indicate other kinds of graphical and textual displays, such as a of a personal computer. FIG. 7 schematically shows one system 800 for real-time allocation of digital content to one or more personal computers 880. A live feed server 892 operates to feed live (i.e., continually or periodically updated) information to a live display application 890 running on personal computer 880. Live display application 890 displays this live information (illustratively shown as live content 888) on a display 882 of personal computer 880. In one example, live feed server 892 supplies live information (such as information displayed on a stadium display) to personal computer 880, thereby allowing a user of personal computer 880 to view the live information. Fenway Park for example utilizes live feed server 892 to feed live baseball scores to a plurality of live display applications 890, each running on personal computers 880. Live feed server 892 and live display application 890 also includes advertisement space 886 on display 882. In another example, Fenway park utilizes live feed server 892 to send a digital video feed (as displayed upon the stadium display) to each personal computer 880, and the live feed may be interspersed with advertisement space that is auctioned by system 800. For example, where video displayed within the stadium in interspersed with advertisement, these advertisement time slots may be auctioned by system 800 such that digital content associated with the winning bid appears upon display 882 of personal computer 880.

An advertisement space database 830 is populated with information (e.g., advertisement space information 821) by advertisement space owner 820; advertisement space owner 820 may own and operate live feed server 892. Owner 820 for example pays a fee to register advertisement space 886 with system 800. Advertisement space database 830 contains information of live feed server 892, including pertinent details associated with selling advertisement space 886 and time on display 882 of personal computer 880. A content provider 825 (also shown as a computer terminal communicatively connected with system 800) searches advertisement space database 830 for an advertisement space that meets desired advertising criteria. In one example, content provider 825 accesses advertisement space database 830 via the Internet using the illustrated computer terminal. Upon selecting a suitable advertisement space (e.g., advertisement space 886 in this example) from advertisement space database 830, content provider 825 submits content 826, such as digital media that is properly formatted and tagged for advertisement space 886, to a submission database 840. It will be appreciated that while content 826 may be a conventional advertisement or commercial, content 826 may also be any graphical and/or textual digital content, including but not limited to: emergency postings (e.g., by the National Weather Service), public service information, such as information pertaining to road conditions or closures; a personal message or greeting; an announcement; an e-mail address; a photograph; a video clip, a survey and the like.

Advertisement space owner 820 accesses submission database 840 to evaluate content 826 submitted advertisement space 886. If approved, content 826 is stored in an approved content database 850. Advertising space database 830, submission database 840 and approved content database 850 may be part of the same database 845, as shown. In one example, submission database 840 and approved content database 850 are subsets of a single content database (not shown). In one embodiment, submission database 840 and approved content database 850 are combined and include one or more fields associated with each item of submitted content, to indicate approval or disapproval for selected advertisement spaces. Approved content database 850 thus includes content (e.g., content 826) that is suitable (per criteria of advertisement space owner 820) and ready to be displayed within advertisement space 886. Content provider 825 is therefore eligible to participate in an auction for one or more time slots of advertisement space 886 in which to display the content. Potential content for advertisement space 886 is “approved” by owner 20 in advance of any time slot auction associated with advertisement space 886, and may be loaded into memory of live feed server 892 such that it is ready to be displayed within advertisement space 886 of dynamic display 882. Content (e.g., content 826) may be approved by multiple advertisement space owners for playing within multiple advertisement spaces.

An auction engine 860 matches content providers 825 to advertisement space owners 20 based upon approved content for each advertisement space (e.g., advertisement space 886), and then determines which, if any, approved content is selected for display within the advertisement space using a bidding methodology. Auction engine 860 employs one or more bidding methodologies defined by each advertisement space owner (e.g., owner 820). Bidding methodologies include, but are not limited to, fixed or variable price, pricing granularity and using a traditional or reverse auction. In an embodiment, auction engine 860 creates a virtual “wall” between content provider 825 and advertisement space owner 820 such that the bidding methodology, the reserve price for time slots, the maximum bid and the latest bid are not available to the content providers and/or advertisement space owners (e.g., the advertisement space owner is not aware of the content provider's maximum bid and the content provider is not aware of the reserve price for a time slots of the advertisement space).

Upon closing of an auction for a particular timeslot, auction engine 860 passes the identification of the winning content (content 826 in this example) and associated provider 825 to a content distributor 870. Content distributor 870 then distributes the winning content (or identification thereof where approved content has already been distributed and stored within memory of live feed server 892) to live feed server 892. This content distribution may be similar to distribution in existing web server architectures, with enhancements to permit real time operation. Where live feed server 892 has limited local storage, content distributor 870 may evaluate the speed of potential content distribution paths to ensure that the auction ends soon enough to allow any content to be delivered to the server prior to scheduled display time. Live feed server 892 has local storage to hold approved content (e.g., sufficient local storage to hold all approved content for advertisement space 886 for an appropriate period, such as ten minutes). This local storage is updated by content distributor 870 to ensure that content for display within advertisement space 886 is local prior to its designated time slot. Thus, when an auction ends, content distributor 870 transfers the identity of the winning content to live feed server 892 and any content no longer required may be flushed from the web server's local storage.

In an embodiment, advertisement space database 830, submission database 840, approved content database 850, auction engine 860 and content distributor 870 are located on a server that is accessible by both owner 820 and content provider 825. In another embodiment, content distributor 870 is a wireless device that is remote from a server that includes databases 830, 840 and 850 and auction engine 860. Advertisement space database 830, submission database 840, approved content database 850 and auction engine 860 may be located on a single server, multiple server(s) at a single location or multiple servers at a number of locations.

Since live feed server 892 receives other content for display on personal computer 880, such as a live feed from a stadium display during a sporting event, display 882 shows live content 888 from the live feed and content resulting from a real-time auction (i.e., through the use of system 800) of advertisement space 886.

In one example, live feed server 880 divides connected personal computers 880 into geographic regions (such as states) as sells advertisement space 886 based upon those geographic regions. Thus, system 800 may hold multiple auctions for each time slot of advertisement space 886. Further, system 800 may provide content to more than one live feed server without departing from the scope hereof.

Live feed server 892 may collect statistical information (e.g., a number of connected live display applications 890 within each geographic area) that is fed back to system 800 as feedback 894. Feedback 894 may be used by auction engine 860 when evaluating bidding parameters of content providers 825 for each time slot of advertisement space 886. That is, content providers 825 may specify bidding rules based upon feedback 892.

Changes may be made in the above systems and methods without departing from the scope hereof. For example, the method steps described herein need not occur in the order in which they are presented. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A system for real-time allocation of digital content to a digital sign, comprising:
a sign database including information representative of one or more digital signs;
a content database for storing digital content from a content provider, the content database being reviewable by a sign owner;
an auction engine for matching the digital content to at least one of the digital signs; and
a content distributor for distributing the matched content to the digital sign.

2. The system of claim 1, the content database comprising:
a submitted content database for processing submission of digital content from the content provider; and
an approved content database for storing digital content from the submitted content database that is approved by the sign owner.

3. The system of claim 2, the submitted content database and the approved content database comprising subsets of the content database.

4. The system of claim 2, the approved content database comprising digital content that is tagged with an approval indicator.

5. The system of claim 1, wherein said sign database contains information representative of digital signs of one or more sign owners.

6. The system of claim 2, the digital content in the approved content database comprising digital media approved for play on the sign in one or more time slots selected by the content provider.

7. The system of claim 1, the digital content in the content database comprising a rating assigned by the content provider or the sign owner.

8. The system of claim 1, the content database being accessible by multiple sign owners.

9. The system of claim 2, wherein the approved content database stores content approved for play on one or more digital signs owned by the sign owner.

10. The system of claim 2, wherein the digital content in the approved content database is rated by the sign owner.

11. The system of claim 2, wherein the digital content in the approved content database is given an expiry date by the sign owner.

12. The system of claim 1, the digital content having a valid date supplied by the content provider, the valid date specifying a period when the digital content is available for display.

13. The system of claim 1, wherein auction engine functionality is determined by parameters input to the system by the sign owner.

14. The system of claim 13, the parameters comprising one or more of sign location, number of pixels, resolution, refresh rate, spot duration, spot time, times of sign operation, anticipated impressions as a function of time of day, anticipated length of impression, anticipated viewer demographics, acceptable content ratings, pricing granularity and type of auction.

15. The system of claim 1, wherein auction engine functionality is determined by parameters input to the system by the content provider.

16. The system of claim 15, the parameters comprising one or more of pixels, resolution, refresh rate, spot duration, spot time, times of sign operation, location of sign, anticipated impressions as a function of time of day, anticipated length of impression, anticipated viewer demographics and maximum price.

17. The system of claim 1, the digital signs comprising a network, further comprising a feedback path for processing information provided by the digital signs on the network.

18. The system of claim 1, the matched content comprising bundled content and bundle parameters, the content distributor utilizing the bundle parameters to select the content for distribution.

19. A method for real-time allocation of digital content to digital signs, comprising:
processing sign parameters for a digital sign in a sign database;
processing sales parameters for the digital sign in the sign database;
processing digital content in a submitted content database;
permitting access to the submitted content database for review of the digital content by a digital sign owner;
tagging digital content approved by the digital sign owner with an approval indicator;
processing bidding parameters for a time slot on the digital sign;
auctioning the time slot to providers of the approved digital content;
distributing the approved digital content to the digital sign; and
airing winning content during the time slot.

20. The method of claim 19, wherein the step of processing digital sign parameters comprises processing parameters for two or more digital signs.

21. The method of claim 19, wherein auctioning is performed according to an auction style selected by the sign owner.

22. The method of claim 21, the auction style comprising reverse auctioning or traditional auctioning.

23. The method of claim 19, wherein the step of processing sales parameters for the digital sign is performed as a function of one or both of the time slot and a pre-selected auction style.

24. The method of claim 19, wherein tagging digital content comprises tagging digital content that is approved for two or more signs.

25. The method of claim 19, wherein tagging digital content comprises tagging digital content that is approved for two or more time slots on the digital sign.

26. The method of claim 19, wherein distributing the approved digital content to the digital sign comprises distributing a portion or all of the approved content to the digital sign.

27. The method of claim 26, further comprising removing losing approved content from the digital sign.

28. The method of claim 19, wherein distributing content to the digital sign comprises determining content from bundled content based upon associated bundle parameters.

29. The method of claim 19, further comprising:
processing sign parameters for a second digital sign in the sign database;
processing sales parameters for the second digital sign in the sign database;
tagging digital content approved by the digital sign owner for the second sign;
processing bidding parameters for a time slot on the second digital sign;
auctioning the time slot on the second digital sign to one or more providers of the approved digital content;
distributing the approved digital content to the second digital sign; and
airing winning content on the second digital sign during the time slot.

30. The method of claim 19, further comprising accepting bidding parameters from the content provider.

31. The method of claim 30, wherein the bidding parameters are received immediately prior to commencement of the time slot.

32. A software product comprising instructions, stored on computer-readable media, wherein the instructions, when executed by a computer, perform steps for real-time allocation of digital content to digital signs, comprising:
instructions for obtaining data indicative of sign owner parameters;
instructions for obtaining data indicative of content provider parameters;
instructions for identifying content that is approved by the sign owner;
instructions for carrying out an auction; and
instruction for distributing approved content to one or more digital signs.

33. A system for displaying digital content received over a digital signage network from a remote digital content marketplace, comprising:
a digital sign;
a receiver, coupled with the digital sign, for receiving digital content that is approved for display on the digital sign;
a storage device in communication with the digital sign, for temporarily storing the approved content;
a sensor for providing feedback representative of activity local to the digital sign to the receiver; and
a transmitter coupled with the receiver, for transmitting the feedback to the digital content marketplace.

34. A system for real-time allocation of digital content to a digital sign, comprising:
a database including digital sign information of one or more digital signs; and
an auction engine for matching digital content to the one or more digital signs.

35. A method for real-time allocation of digital content to digital signs, comprising:
processing sign parameters for a digital sign in a sign database;
processing sales parameters for the digital sign in the sign database;
processing digital content in a submitted content database;
permitting access to the submitted content database by a digital sign owner, for review of the digital content;
tagging digital content approved by the digital sign owner with an approval indicator;
processing bidding parameters for a time slot on the digital sign;
auctioning the time slot to providers of the approved digital content based upon the bidding parameters and the sales parameters;
distributing the approved digital content to the digital sign; and
airing approved digital content of the winning provider on the digital sign during the time slot.

36. A method for displaying digital content on a digital sign, comprising:
accessing a database containing information about one or more digital signs;
selecting a digital sign from the database;
submitting digital content to the database for approval by an owner of the selected digital sign;
receiving approval of the digital content from the owner; and
entering a bid for display of the digital content on the selected digital sign.

37. The method of claim 36, entering a bid comprising entering a bid for display of the digital content in a selected time slot on the selected digital sign.

38. The method of claim 36, further comprising entering a trigger, wherein occurrence of the trigger activates bidding.

39. The method of claim 38, the trigger comprising a sporting event, wherein the sign is located proximate the sporting event.

40. The method of claim 39, the sporting event selected from the group consisting of a run, a basket, a goal, an ace, a fight, a close score, a tie, a win, a loss and a play by a selected athlete.

41. The method of claim 40, the trigger comprising a traffic jam on a highway, wherein the sign is located proximate the highway.

42. The method of claim 36, entering a bid comprising entering parameters that govern bidding.

43. The method of claim 42, bidding parameters comprising one or more of intervals between play of content, maximum bid, a bidding function and a bidding equation.

44. A method for allocating and displaying digital content on dynamic digital signs, comprising:
accepting dynamic digital sign sales parameters for one or more dynamic digital signs of a digital signage network;
accepting proposed digital content for display upon at least one of the one or more dynamic digital signs;
accepting bidding parameters associated with the proposed digital content;
determining an auction close time based upon the dynamic digital sign sales parameters;
entering bids to the auction based upon the bidding parameters;
auctioning a time slot on the one or more dynamic digital signs based upon the entered bids;
determining, at an auction close time, a winning bid; and
distributing the digital content associated with the winning bid to the one or more dynamic digital signs for display.

45. The method of claim 44, further comprising tagging proposed digital content with an approval indicator when an owner of the one of the dynamic digital displays indicates approval of the digital content for display on the one or more dynamic digital signs, wherein bids are not entered to the auction for proposed digital content not tagged with the approval indicator.

46. The method of claim 45, further comprising storing the tagged proposed digital content local to the dynamic digital sign prior to the auction close time.

47. A method for selecting and displaying digital content within an advertising space, comprising:
accepting advertising space sales parameters for one or more advertising spaces;
accepting proposed digital content for display within at least one of the one or more advertising spaces;
accepting bidding parameters associated with the proposed digital content;
determining an auction close time based upon the advertising space sales parameters;
entering bids to the auction based upon the bidding parameters;
auctioning a time slot for the one or more advertisement spaces based upon the entered bids;
determining, at the auction close time, a winning bid;
distributing the digital content associated with the winning bid for display within the one or more advertisement spaces.

48. The method of claim 47, further comprising tagging proposed digital content with an approval indicator when an owner of one or more advertisement spaces indicates approval of the digital content for display on the one or more advertisement spaces, wherein bids are not entered to the auction for proposed digital content not tagged with the approval indicator.

49. The method of claim 48, further comprising storing the tagged proposed digital content local to the advertisement space prior to the auction close time.

50. A system for real-time allocation of digital content to an advertisement space, comprising:
an advertisement space database including information representative of one or more advertisement spaces;
a content database for storing digital content from a content provider, the content database being reviewable by an owner of the one or more advertisement spaces;
an auction engine for matching the digital content to at least one of the advertisement spaces; and
a content distributor for distributing the matched content to the advertisement space.

51. The system of claim 50, the advertisement space being located on a personal computer displaying live information from a live feed server.
